(19) United States
(12) Patent Application Publication
(10) Pub. No.: US 2015/0262515 A1
(43) Pub. Date: Sep. 17, 2015

(54) Cord Clamp Identifiers

(71) Applicants: Jessica Leonardis, Watsonville, CA (US); Alicia Gurnee, Watsonville, CA (US)

(72) Inventors: Jessica Leonardis, Watsonville, CA (US); Alicia Gurnee, Watsonville, CA (US)

(21) Appl. No.: 14/643,055

(22) Filed: Mar. 10, 2015

Related U.S. Application Data
(60) Provisional application No. 61/951,037, filed on Mar. 11, 2014.

(51) Int. Cl. G09F 3/14; G09F 3/16

(52) U.S. Cl. CPC G09F 3/14; G09F 3/16; G09F 2003/023

(57) ABSTRACT

An identification bead includes a first element having a size and shape with engagement elements and a first trough from one edge to another, a second element having the same size and shape with engagement elements, a second trough from one edge to another, a surface for addition of indicia, and rubber-like insert elements with half-cylindrical troughs matching the troughs of the rigid elements, and a thickness. The first and second rigid elements are enabled to join with the engagement elements engaged and the insert elements between the rigid elements with the half-cylindrical first and second troughs facing in a manner to provide a cylindrical channel for a wire or cable, such that the joining of the rigid elements deforms the insert elements, placing pressure on a wire or cable passing through the cylindrical channel.

### CROSS-REFERENCE TO RELATED APPLICATIONS

The present application claims priority to Provisional Patent Application 61/951,037 filed Mar. 11, 2014. All disclosure of the parent application is incorporated herein at least by reference.

### BACKGROUND OF THE INVENTION

1. Field of the Invention

The present invention is in the technical field of annotating wiring individually in clusters.

2. Description of Related Art

The present inventors have identified an unmet need having to do with certain electric and electronic devices. Many such devices, such as, for example, AC/DC converters for electronic devices, such as Pad units and cellular telephones, among many more such appliances requiring that their batteries be charged on a regular basis, are regularly disconnected from the appliances to which they are essential, and may be stored perhaps with other such power supply and charger devices. The devices quite often may be labeled as to AC input voltage and DC output voltage, but may not in many cases be identified specifically for the appliances they are meant to power or charge.

The unmet need clearly is that a secure and reusable unit is needed that can be clamped around a cord of an AC/DC converter meant as a charger for a particular battery-powered appliance, or a cord in general in any situation where association of the unit to which the cord is attached is critical or otherwise desired. Another shortcoming of the prior art is that identifiers cannot accommodate attachment to cords or cables of different diameter.

### BRIEF SUMMARY OF THE INVENTION

In an embodiment of the invention an identification bead is provided, comprising a first rigid element having a first size and peripheral shape, comprising on one side first engagement elements in a first geometric spacing and a half-cylindrical first trough from one edge to an opposite edge, a second rigid element having the same size and peripheral shape as the first rigid element, comprising on one side second engagement elements in the same geometric spacing as on the first rigid element, a half-cylindrical second trough from one edge to an opposite edge, and a surface opposite the side presenting the half-cylindrical second trough, providing a surface for addition of indicia, and a first and a second rubber-like insert element each having substantially the same size and peripheral shape as the rigid elements, half-cylindrical troughs matching the first and second troughs of the rigid elements, and a thickness, the insert elements having pass-through openings for the engagement elements. The first and second rigid elements are enabled to join with the engagement elements engaged and the insert elements between the rigid elements with the half-cylindrical first and second troughs facing in a manner to provide a cylindrical channel for a wire or cable, such that the joining of the rigid elements deforms the insert elements, placing pressure on a wire or cable passing through the cylindrical channel.

In one embodiment, with the rigid elements joined, securing the identification bead to a wire or cable, an identification sticker is adhered to the surface of the second rigid element provided for addition of indicia, the sticker identifying the wire or cable, or a device served by the wire or cable. Also in one embodiment, with the rigid elements joined, the sticker is blank, proving a surface for a user to add indicia with a pen or marker.

In one embodiment the shape of the identification bead assembled is a flat, round disk. Also in one embodiment the shape of the identification bead assembled is a flat, substantially rectangular tile. Also in one embodiment the engagement elements comprise posts and receptacle openings arranged in the geometric pattern, such that posts on each rigid element engage receptacle openings on the other rigid element as the two are joined.

In one embodiment the two rubber-like insert elements are joined at one edge forming a hinge about which the insert elements and rigid elements may rotate in joining around a wire or cable. And in one embodiment the half-cylindrical troughs in the rigid elements comprise one or more lengthwise grooves, allowing volume for expansion of material of the rubber-like insert elements when the rigid elements are engaged around a wire or cable.

In another aspect of the invention a method identifying a wire or cable is provided, the method comprising placing a first rubber-like insert having a first size and peripheral shape on a first rigid element having a having substantially the same size and peripheral shape, the first rigid element comprising on one side first engagement elements in a first geometric spacing and a half-cylindrical first trough from one edge to an opposite edge, the insert providing clearance for the engagement elements and a thickness of the rubber-like material in the half-cylindrical first trough, placing a second rubber-like insert having the first size and peripheral shape on a second rigid element having substantially the same size and peripheral shape, the second rigid element comprising on one side second engagement elements in the same geometric spacing and a half-cylindrical second trough from one edge to an opposite edge, the insert providing clearance for the engagement elements and a thickness of the rubber-like material in the half-cylindrical second trough, and engaging the first and second rigid elements by the engagement elements with the rubber-like inserts between, around a wire or cable passing through a cylindrical passage thus formed by the first and second troughs lined by a thickness of the rubber-like material, the engagement forming an identification bead compressing the rubber-like material around the wire or cable, providing a firm attachment, and providing at least one surface for placing an identifying indicia.

In one embodiment of the method, with the rigid elements joined, securing the identification bead to a wire or cable, an identification sticker is adhered to the at least one surface of the second rigid element, the sticker identifying the wire or cable, or a device served by the wire or cable. Also in one embodiment, with the rigid elements joined, the sticker is blank, proving a surface for a user to add indicia with a pen or marker.

In one embodiment the shape of the identification bead assembled is a flat, round disk. Also in one embodiment the shape of the identification bead assembled is a flat, substantially rectangular tile. In one embodiment the engagement elements comprise posts and receptacle openings arranged in the geometric pattern, such that posts on each rigid element engage receptacle openings on the other rigid element as the two are joined.

IN one embodiment the two rubber-like insert elements are joined at one edge forming a hinge about which the insert elements and rigid elements may rotate in joining around a wire or cable. And in one embodiment the half-cylindrical troughs in the rigid elements comprise one or more lengthwise grooves, such that joining the rigid elements compresses a portion of the inserts into the grooves.

### BRIEF DESCRIPTION OF THE SEVERAL VIEWS OF THE DRAWINGS

FIG. 1 is a perspective view of an ID Bead clamp assembled and clamped over a wire in an embodiment of the present invention.

FIG. 2 is an assembly view of the clamp of FIG. 1 in open mode in an embodiment of the present invention.

FIG. 3 is a perspective view of a rubber-like insert of the clamp assembly of FIG. 2 in an embodiment of the present invention.

FIG. 4 is a perspective view of the rigid parts of the clamp of FIG. 2 in an embodiment of the invention.

FIG. 5 is a perspective view of an assembled ID clamp in an alternative embodiment of the invention.

FIG. 6 is a plan view from above of the ID clamp of FIG. 5, shown open.

FIG. 7 is an end elevation view of the ID clamp of FIG. 5.

FIG. 8 is a perspective view of an ID clamp in an alternative embodiment of the invention.

### DETAILED DESCRIPTION OF THE INVENTION

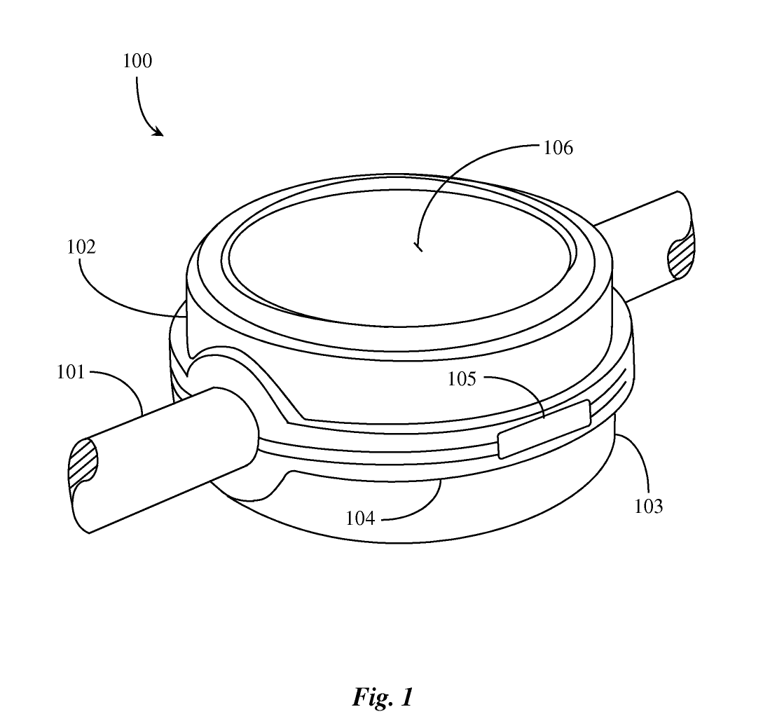

FIG. 1 is a perspective view of an ID clamp 100 assembled and clamped over a wire 101 in an embodiment of the present invention. The inventors refer to the clamp assembly as an ID Bead. Clamp 100 comprises two separate rigid or semi-rigid elements 102 and 103 which may be injection-molded polymer, metal casting, die cast, or other suitable material, and a rubber-like insert 104 which is assembled between rigid elements 102 and 103. Insert 104 may in fact be natural or synthetic rubber, or may be made of a rubber-like polymer. Purposes of insert 104 are to form a high-friction engagement to wire 101, and to enable the clamp assembly 100 to clamp securely to wires 101 over a range of wire diameters. Element 105 in FIG. 1 indicates a portion of insert 104 in one embodiment that forms a hinge for the clamp assembly. Elements 102 and 103 in one embodiment are provided with a recessed area 106 for attaching an adhesive label, which may be pre-printed, or may be a blank label that a user may annotate, such as with a pen, pencil or other marker. Further details of these elements are described below.

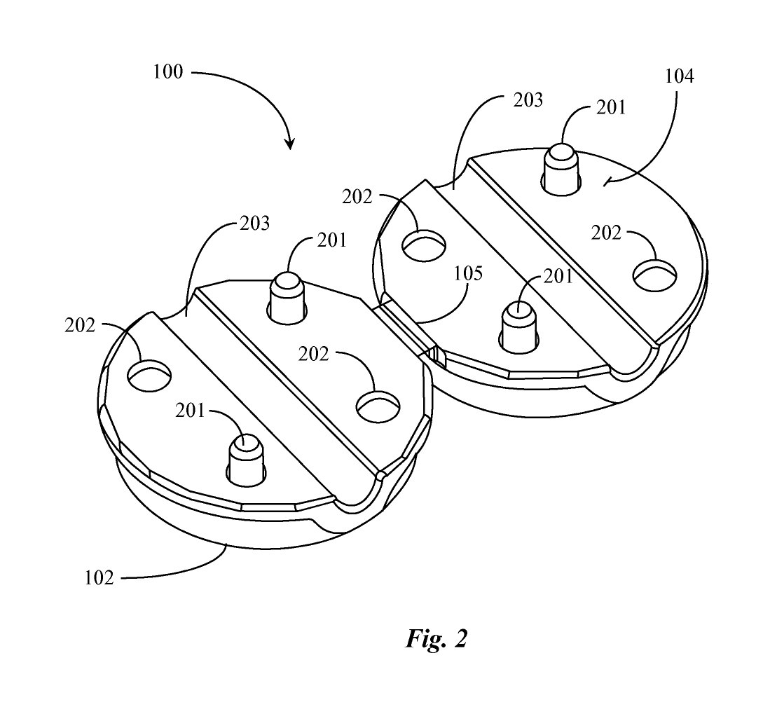

FIG. 2 is an assembly view of clamp 100 of FIG. 1 in open aspect in an embodiment of the present invention. Each of rigid elements 102 and 103 in this particular embodiment has two posts 201 in this embodiment that are meant to match and engage receptacle openings (not seen in FIG. 2) in the opposite rigid element in a way to securely align and securely clamp the rigid elements together, as seen in FIG. 1. Insert 104 in this view is illustrated in unfolded aspect, in which each half has the form factor of one of the rigid elements, and the two halves are joined by strap 105, which serves as a hinge for the assembly. Openings 202 in the insert provide access for posts 201 of each rigid element to engage receptacle openings (not shown in FIG. 2) in the opposite rigid element. A half-pipe shaped region 203 is shown in each half of the insert, the regions 203 coming together as the clamp is closed to surround and clamp to a wire in use.

It should be understood that two halves for the rubberlike insert joined by hinge strap 105 are not strictly necessary for the invention. In an alternative embodiment there may be just one of the two halves shown, such that when the rigid elements are joined around a wire, the one insert may clamp the wire against a rigid surface of the opposite rigid element. In another alternative there may be a rubber-like insert associated with each rigid element, but the inserts may be separate and not joined by a hinge element.

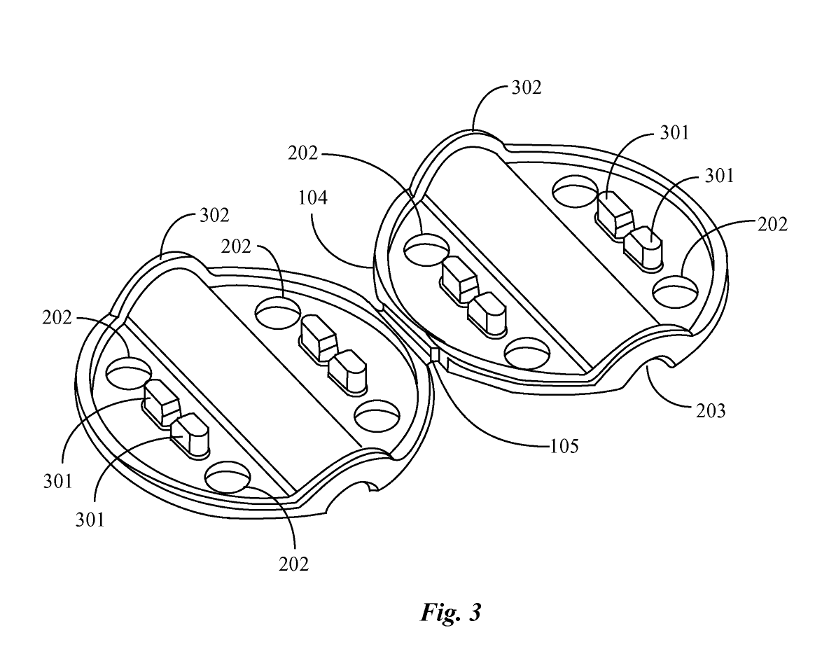

FIG. 3 is a perspective view of rubber-like insert 104 of the clamp assembly of FIG. 2 in an embodiment of the present invention, illustrating additional detail of the insert. In this view the insert is illustrated upside-down from the view of FIG. 2, with the sides up that will actually contact rigid elements 102 and 103 in assembly. Several projections 301 are provided which help engage indentions in the rigid elements that serve to align the insert to the rigid elements, but are not deemed essential in the design. A lip 302 is provided in this embodiment around the periphery of each half of the insert, and the inside diameter and shape of the lip matches the outer periphery of each rigid element to which the insert engages, providing the outside extension of the insert as seen in FIG. 1. The arch shape of half-pipe regions 203 is seen in FIG. 3 as well as opening 202, but not all regions 203 and openings 202 are marked, to avoid confusion.

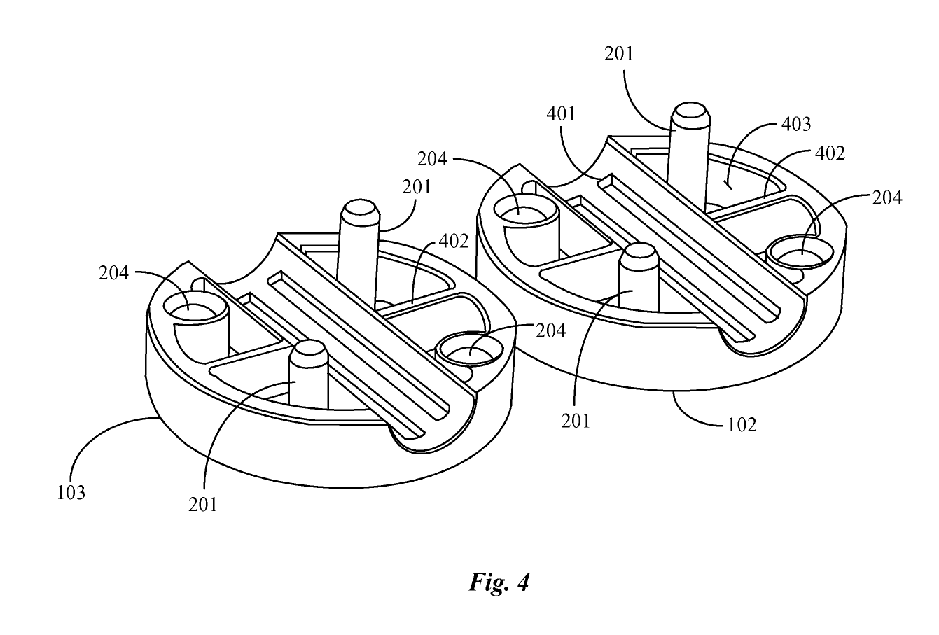

FIG. 4 is a perspective view of the rigid parts 102 and 103 of clamp 100 of FIGS. 1 and 2 in an embodiment of the invention, shown without insert 104. Posts 201 (two for each rigid element) are shown. A cross-ridge 402 in each rigid element provides rigidity and strength. Open areas 403 reduce mass. Channels 401 in one embodiment provide expansion room for the rubber-like material of the insert that actually is compressed against a wire in use. Receptacle openings 204 to engage posts 201 are illustrated as well. In one embodiment the posts are tapered by perhaps one to three degrees and the receptacle openings are likewise tapered, such that a force-fit is accomplished when the posts are urged into the openings. In other embodiments there may be a latch shape between the posts and receptacle openings provided to cause a latch action. Other ways are known as well to cause the posts and openings to engage.

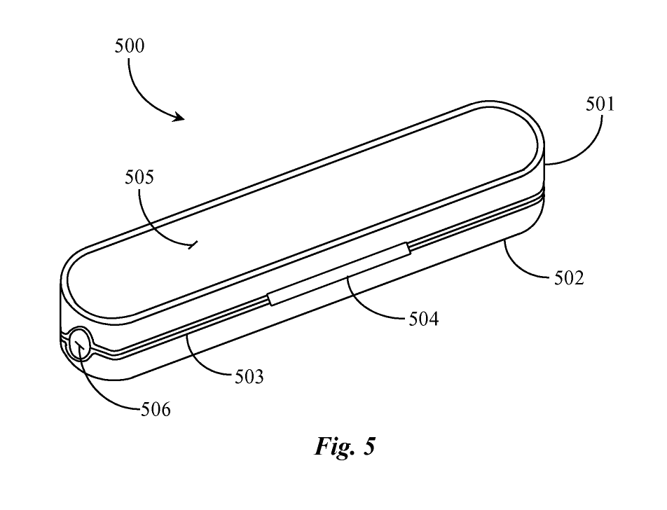

FIG. 5 is a perspective view of an assembled ID clamp 500 in an alternative embodiment of the invention. ID clamp 500 has many characteristics in common with the round ID clamps described above with reference to FIGS. 1-4, but is elongated in the direction of a wire to which the clamp is meant to attach. The inventor terms this clamp a “tile”. In various embodiments of the invention the ID Beads may take shapes other than the round shape and the tile shape shown in the figures, such as oval, rectangular with rounded corners, triangular, and other shapes.

There are two independent rigid portions 501 and 502 in the embodiment illustrated in FIG. 5, and a rubber-like insert 503, as in previous versions described. The insert in this embodiment has a hinge flap 504. A recessed area 505 provides a region for an adhesive label, or in some embodiments a region where a user may annotate the clamp with text and characters. It is not required that the annotation region be recessed. Opening 506 illustrates where I wire would enter or exit the tile.

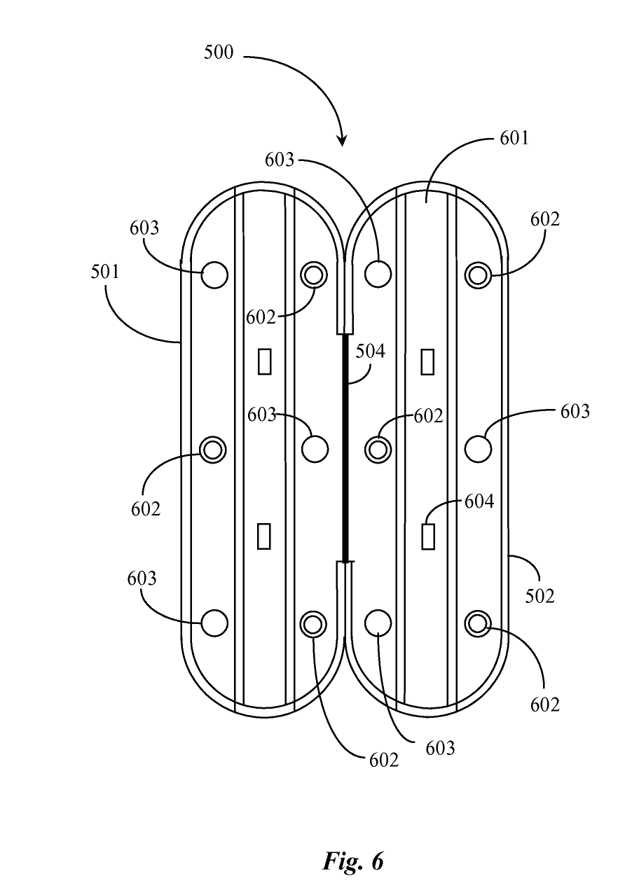

FIG. 6 is a plan view from above of the ID clamp of FIG. 5, shown open, with an insert 601 in place. The rigid portions 501 and 502 have posts 602 and openings 603 for accepting the posts and holding the clamp together when closed. Elements 604 are analogous to elements 301 in FIG. 3. Element 504 is the hinge flap.

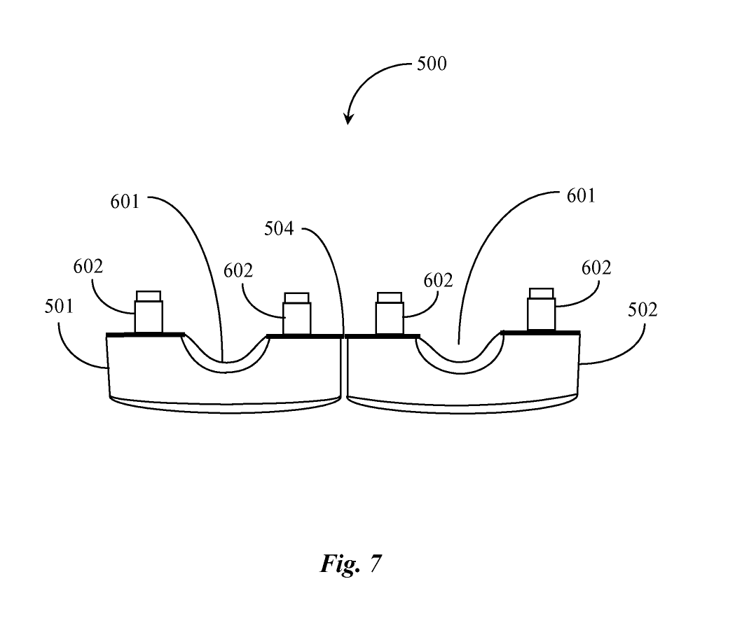

FIG. 7 is an end elevation view of the ID clamp of FIG. 5. Rigid parts 501 and 502, insert 601 with hinge flap 504, and posts 602 are identified.

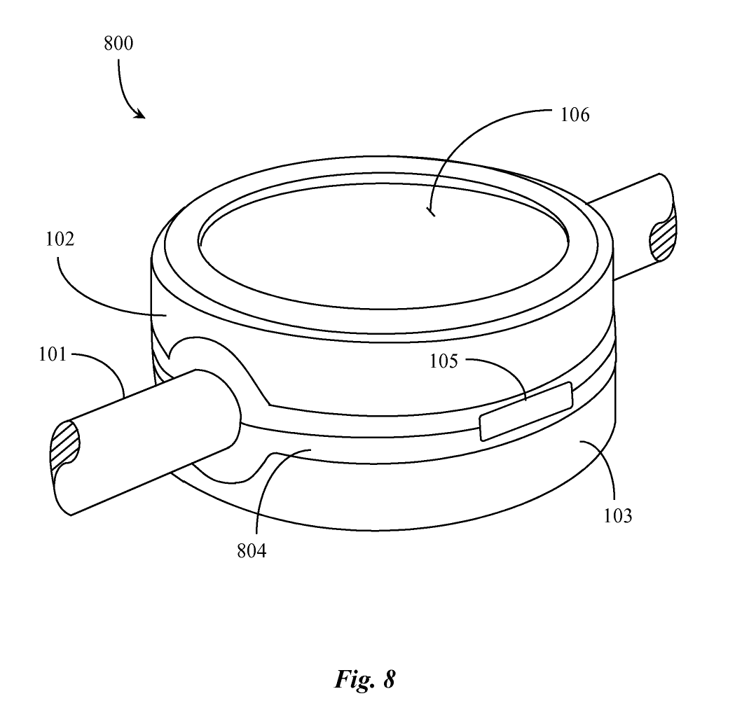

It will be apparent that in some figures the rubber-like insert is shown as having a somewhat greater diameter than the rigid elements, such that the insert protrudes somewhat outward from the rigid elements. This is simply a matter of design choice, and the diameter of the insert may in some embodiments be the same as or less than the diameter of the rigid elements. FIG. 8 illustrates an ID clamp 800 in which insert 804 is of the same diameter as the diameter of the rigid elements, which bear the same element numbers as the ID clamp of FIG. 1. In some other embodiments the diameter of the insert may be smaller than the diameter of the rigid elements.

It will be apparent to the skilled person that many diverse shapes may be accomplished other than the disk and the tile shapes shown and described. In one embodiment rigid elements are provided that make a spherical shape when joined. In another a heart shape may be provided. In these embodiments there may or may not be an insert. Various colors and finishes are provided in many different embodiments, such as gloss black, silver, and gold. Color may be applied for the rubber-like inserts as well. Round clamps may be used as spacers between disks or tiles, or may be provided just for aesthetic effect.

1. An identification bead, comprising:
a first rigid element having a first size and peripheral shape, comprising on one side first engagement elements in a first geometric spacing and a half-cylindrical first trough from one edge to an opposite edge;
a second rigid element having the same size and peripheral shape as the first rigid element, comprising on one side second engagement elements in the same geometric spacing as on the first rigid element, a half-cylindrical second trough from one edge to an opposite edge, and a surface opposite the side presenting the half-cylindrical second trough, providing a surface for addition of indicia; and
a first and a second rubber-like insert element each having substantially the same size and peripheral shape as the rigid elements, half-cylindrical troughs matching the first and second troughs of the rigid elements, and a thickness, the insert elements having pass-through openings for the engagement elements;
wherein the first and second rigid elements are enabled to join with the engagement elements engaged and the insert elements between the rigid elements with the half-cylindrical first and second troughs facing in a manner to provide a cylindrical channel for a wire or cable, such that the joining of the rigid elements deforms the insert elements, placing pressure on a wire or cable passing through the cylindrical channel.

2. The identification bead of claim 1 wherein, with the rigid elements joined, securing the identification bead to a wire or cable, an identification sticker is adhered to the surface of the second rigid element provided for addition of indicia, the sticker identifying the wire or cable, or a device served by the wire or cable.

3. The identification bead of claim 2 wherein, with the rigid elements joined, the sticker is blank, proving a surface for a user to add indicia with a pen or marker.

4. The identification bead of claim 1 wherein the shape of the identification bead assembled is a flat, round disk.

5. The identification bead of claim 1 wherein the shape of the identification bead assembled is a flat, substantially rectangular tile.

6. The identification bead of claim 1 wherein the engagement elements comprise posts and receptacle openings arranged in the geometric pattern, such that posts on each rigid element engage receptacle openings on the other rigid element as the two are joined.

7. The identification bead of claim 1 wherein the two rubber-like insert elements are joined at one edge forming a hinge about which the insert elements and rigid elements may rotate in joining around a wire or cable.

8. The identification bead of claim 1 wherein the half-cylindrical troughs in the rigid elements comprise one or more lengthwise grooves, allowing volume for expansion of material of the rubber-like insert elements when the rigid elements are engaged around a wire or cable.

9. A method identifying a wire or cable, comprising:
placing a first rubber-like insert having a first size and peripheral shape on a first rigid element having a having substantially the same size and peripheral shape, the first rigid element comprising on one side first engagement elements in a first geometric spacing and a half-cylindrical first trough from one edge to an opposite edge, the insert providing clearance for the engagement elements and a thickness of the rubber-like material in the half-cylindrical first trough;
placing a second rubber-like insert having the first size and peripheral shape on a second rigid element having substantially the same size and peripheral shape, the second rigid element comprising on one side second engagement elements in the same geometric spacing and a half-cylindrical second trough from one edge to an opposite edge, the insert providing clearance for the engagement elements and a thickness of the rubber-like material in the half-cylindrical second trough; and
engaging the first and second rigid elements by the engagement elements with the rubber-like inserts between, around a wire or cable passing through a cylindrical passage thus formed by the first and second troughs lined by a thickness of the rubber-like material, the engagement forming an identification bead compressing the rubber-like material around the wire or cable, providing a firm attachment, and providing at least one surface for placing an identifying indicia.

10. The method of claim 9 wherein, with the rigid elements joined, securing the identification bead to a wire or cable, an identification sticker is adhered to the at least one surface of the second rigid element, the sticker identifying the wire or cable, or a device served by the wire or cable.

11. The method of claim 10 wherein, with the rigid elements joined, the sticker is blank, proving a surface for a user to add indicia with a pen or marker.

12. The method of claim 9 wherein the shape of the identification bead assembled is a flat, round disk.

13. The method of claim 9 wherein the shape of the identification bead assembled is a flat, substantially rectangular tile.

14. The method of claim 9 wherein the engagement elements comprise posts and receptacle openings arranged in the geometric pattern, such that posts on each rigid element engage receptacle openings on the other rigid element as the two are joined.

15. The method of claim 9 wherein the two rubber-like insert elements are joined at one edge forming a hinge about which the insert elements and rigid elements may rotate in joining around a wire or cable.

16. The method of claim 9 wherein the half-cylindrical troughs in the rigid elements comprise one or more lengthwise grooves, such that joining the rigid elements compresses a portion of the inserts into the grooves.
